(19) United States
(12) Patent Application Publication
(10) Pub. No.: US 2015/0189387 A1
(43) Pub. Date: Jul. 2, 2015

(54) METHODS AND SYSTEMS FOR AUTOMATICALLY CORRECTING OVERRUNS DURING FAST-ACCESS PLAYBACK OPERATIONS BASED ON THE ATTENTIVENESS OF A USER

(71) Applicant: United Video Properties, Inc., Santa Clara, CA (US)

(72) Inventors: Phil Golyshko, Pacifica, CA (US); Brian Craig Peterson, Barrington, IL (US); Paul T. Stathacopoulos, San Carlos, CA (US)

(73) Assignee: UNITED VIDEO PROPERTIES, INC., Santa Clara, CA (US)

(21) Appl. No.: 14/143,559

(22) Filed: Dec. 30, 2013

(51) Int. Cl. H04N 21/472; H04N 21/6587; H04N 21/442

(52) U.S. Cl. CPC H04N 21/47202; H04N 21/47217; H04N 21/44218; H04N 21/6587

(57) ABSTRACT

Methods and systems are described herein for a media guidance application that automatically corrects overruns during fast-access playback operations. For example, the media guidance application may base overrun corrections on the attentiveness of the user.

### BACKGROUND

The rise in DVR technology and On-Demand services provides users of typical media systems with a plethora of recording and playback options for viewing programming. For example, in addition to playing back programming at its normal rate, users are able to fast-forward, pause, and rewind programming at will. However, even though users have the option to modify the playback of programming, users still face challenges when performing any modification of the playback of programming. For example, as users perform fast-forward and rewind operations to locate a particular point in the programming, they will invariably fast-forward too far and/or rewind too far, resulting in subsequent operations requiring to be performed in order to locate the particular point in the programming.

### SUMMARY

Accordingly, methods and systems are described herein for a media guidance application that automatically corrects overruns during fast-access playback operations. For example, the media guidance application may base overrun corrections on the content of the media asset subject to the fast-access playback operation and/or the attentiveness of the user.

In some aspects, the media guidance application may automatically correct overruns during fast-access playback operations (e.g., fast-forward or rewind operation) based on the content of the media asset. The media guidance application may receive a user input ending a fast-access playback operation at a first progression point in a media asset. The media guidance application then determines the content of the media asset at the first progression point. The media guidance application then cross-references the content with a database associated with overrun corrections to determine an overrun correction (e.g., a number of frames of the media asset from the first progression point to be skipped) based on the content of the media asset at the first progression point. Based on the overrun correction, the media guidance application automatically selects a second progression point in the media asset for ending the fast-access playback operation and ends the fast-access playback operation at the second progression point.

In some embodiments, the media guidance application continually monitors each progression point's content during the fast-access playback operation and cross-references each progression point's content with the database in real-time. For example, as the user performs the fast-access playback operation, the media guidance application may continuously determine the content of the portions of the media asset subject to the fast-access playback operation. Consequently, when the user input ending the fast-access playback operation is received, the media guidance application may immediately process the overrun correction based on the content of the portions.

In some embodiments, the media guidance application may determine a genre of the media asset and cross-reference the genre with the database associated with overrun corrections to determine the overrun correction based on the genre. For example, the media guidance application may determine whether or not the genre of the media asset is associated with a greater or lesser amount of overrun correction. For example, media assets of the sports genre may be subject to lesser amounts of overrun correction as such fast-access playback operations may be performed by more engaged users (e.g., users carefully rewinding a program to review a close play), whereas media assets of the sitcom genre may be subject to greater amounts of overrun correction as such fast-access playback operations may be performed by less engaged users (e.g., users sporadically fast-forwarding through commercials).

In some embodiments, the media guidance application may determine a level of precision associated with the fast-access playback operation based on the content and select the overrun correction based on the level of user precision. For example, the media guidance application may determine whether or not the genre of the media asset is associated with a greater or lesser amount of overrun correction and select the overrun correction based on the level of user precision. For example, if the content subject to the fast-access playback operation is a sports play, the media guidance application may apply a lesser amount of overrun correction as such fast-access playback operations may be performed by a user searching for a specific frame (e.g., a frame showing whether or not a player is out of bounds), whereas if the content is a comedy program, multiple frames may be suitable (e.g., any frame after a commercials).

In some embodiments, the media guidance application may determine a user associated with the fast-access playback option based on the content and select the overrun correction based on a level of skill associated with the user. For example, the media guidance application may determine based on the particular type of content (e.g., cartoons) being consumed, the type of user (e.g., a young child), as that type of user is likely to consume content of that particular type. Based on the user, the media guidance application may select an overrun correction suitable for that user (e.g., featuring a greater amount of overrun correction to compensate for the limited dexterity and response time associated with a young child).

In some embodiments, the media guidance application determines a portion of the media asset associated with the first progression point and select the second progression point in response to determining that the second progression point corresponds to a beginning point of the portion. For example, in response to determining that a user has ended the fast-access playback operation in the middle of an important scene, the media guidance application may automatically apply an overrun correction that returns the user to the beginning of the important scene.

In some embodiments, the media guidance application may determine a portion of the media asset associated with the first progression point and select an overrun correction based on a correction associated with the portion. For example, if other users that end the fast-access playback operation typically perform subsequent fast-access playback operations (e.g., to manually correct overruns) to arrive at a particular point in the portion, the media guidance application may automatically apply an overrun correction that arrives at the point.

In some aspects, the media guidance application may automatically correct overruns during fast-access playback operations (e.g., fast-forward or rewind operation) based on the attentiveness of a user. The media guidance application may receive a user input ending a fast-access playback operation at a first progression point in a media asset. The media guidance application may then determine an attentiveness level of a user and cross-reference the attentiveness level of the user with a database associated with overrun corrections to determine an overrun correction (e.g., a number of frames of the media asset from the first progression point to be skipped) based on the attentiveness level. The media guidance application then automatically selects a second progression point in the media asset for ending the fast-access playback operation based on the overrun correction and ends the fast-access playback operation at the second progression point.

In some embodiments, the media guidance application continually monitors attentiveness levels of the user during the fast-access playback operation and cross-references attentiveness levels of the user with the database in real-time. For example, as the user performs the fast-access playback operation, the media guidance application may continuously determine the attentiveness levels of the user (and/or any changes therein). Consequently, when the user input ending the fast-access playback operation is received, the media guidance application may immediately process the overrun correction based on a current average, previous average, or other representation of the attentiveness level of the user during the fast-access playback operation.

It should be noted, the systems and/or methods described above may be combined with, applied to, or used in accordance with, other systems, methods and/or apparatuses discussed both above and below.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media guidance display for navigating and selecting media assets in accordance with some embodiments of the disclosure;

FIG. 2 shows another illustrative example of a media guidance display for navigating and selecting media assets in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is an illustrative example of a component used to determine the attentiveness of a user in accordance with some embodiments of the disclosure;

FIG. 6 is a flowchart of illustrative steps for automatically correcting overruns during fast-access playback operations based on the content of a media asset in accordance with some embodiments of the disclosure;

FIG. 7 is a flowchart of illustrative steps for automatically correcting overruns during fast-access playback operations based on the attentiveness of a user in accordance with some embodiments of the disclosure; and

FIG. 8 is a flowchart of illustrative steps for applying an overrun correction in accordance with some embodiments of the disclosure.

### DETAILED DESCRIPTION OF THE DRAWINGS

Methods and systems are described herein for a media guidance application that automatically corrects overruns during fast-access playback operations. For example, the media guidance application may base overrun corrections on the content of the media asset subject to the fast-access playback operation and/or the attentiveness of the user. As used herein, “a media guidance application,” “interactive media guidance application,” or “guidance application” refer to a form of media guidance through an interface that allows users to efficiently navigate, identify, view, and/or obtain information about content that they may desire. In some embodiments, the media guidance application may be provided as an on-line application (i.e., provided on a website), or as a stand-alone application on a server, user device, etc. Various devices and platforms that may implement the media guidance application are described in more detail below. In some embodiments, the media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and nonvolatile computer memory or storage devices such as a hard disk, floppy disk, USB drive, DVD, CD, media card, register memory, processor caches, Random Access Memory (“RAM”), etc.

Media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate, and select content. As referred to herein, the term “media asset” should be understood to mean an electronically consumable user asset, such as television programming, as well as pay-per-view programs, on-demand programs (as in video-on-demand (VOD) systems), Internet content (e.g., streaming content, downloadable content, webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Media guidance applications also allow users to navigate among and locate content. As referred to herein, the term “multimedia” should be understood to mean content that utilizes at least two different content forms described above. For example, text, audio, images, video, or interactivity content forms. Content may be recorded, played, displayed, or accessed by user equipment devices, but can also be part of a live performance.

As referred to herein, the phrase “fast-access playback operations” should be understood to mean any operation that pertains to playing back a non-linear media asset faster than normal playback speed or in a different order than the media asset is designed to be played, such as a fast-forward, rewind, skip, chapter selection, segment selection, skip segment, jump segment, next segment, previous segment, skip advertisement or commercial, next chapter, previous chapter or any other operation that does not play back the media asset at normal playback speed. The fast-access playback operation may be any playback operation that is not “play,” where the play operation plays back the media asset at normal playback speed.

In some embodiments, the media guidance application may automatically correct overruns during fast-access playback operations (e.g., fast-forward or rewind operation) based on the content of the media asset. For example, in order to alleviate the need for subsequent, corrective fast-forward and rewind operations as a result of a user rewinding too far during a fast-access playback operation, the media guidance application automatically applies an overrun correction.

As used herein, “an overrun correction” refers to a finite adjustment from one progression point in a media asset, associated with the end of a fast-access playback operation, to another progression point in the media asset. In some embodiments, an overrun correction may be measured in terms of a number of frames (e.g., one, five, ten, etc.) that are skipped (e.g., in the linear progression of the media asset) from a first progression point to a second progression point. In some embodiments, an overrun correction may be measured in terms of a length of run-time of a media asset (e.g., one second, three seconds, two minutes, etc.) that passes (e.g., in the linear progression of the media asset) from a first progression point to a second progression point. As user herein, “a progression point” refers to a finite instance in the play length of a media asset. For example, a progression point may be associated with a particular frame or playback position in the media asset.

In some embodiments, the media guidance application may receive a user input ending a fast-access playback operation at a first progression point in a media asset. The user input may be received by one or more user devices associated with the media guidance application. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, the media guidance application may be available on these devices, as well. The media guidance application provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

In some embodiments, the media guidance application may determine the content of the media asset and/or the content of a particular segment of the media asset (e.g., at a particular progression point) for use in selecting an overrun correction. As used herein, “content” of the media asset, or a segment of the media asset (e.g., at a particular progression point), refers to any data or information presented or associated with the presentation of the media asset or a segment of the media asset. For example, the content of the media asset (or a segment of the media asset) may refer the identity of the media asset to one or more objects presented during the media asset (e.g., a character, an automobile, etc. in a movie) and the relation of those objects to one another. The content may refer to the circumstances surrounding the media asset (or a segment of the media asset) such as character motivations, plot points, etc. The content of the media asset may also include media guidance data associated with the media asset (or a segment of the media asset).

As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters or providers' logos, etc.), media format (e.g., standard definition, high definition, 3D, etc.), advertisement information (e.g., text, images, media clips, etc.), on-demand information, blogs, websites, and any other type of guidance data that may be used by one or more embodiments discussed herein.

In some embodiments, the media guidance application may receive information related to the content of a media asset. For example, data associated with the media asset may indicate the content of the media asset and/or the content of particular segments of the media asset. In some embodiments, the data may be included with the media asset (e.g., as metadata) or may be stored separately (e.g., as a content profile). If the data is stored separately, the media guidance application may receive this information in order to determine a proper overrun correction. For example, in response to a user request to access a media asset, the media guidance application may query a database (e.g., located locally or remotely) for data related to the content of the media asset. In some embodiments, the media guidance application may determine information related to the content of a media asset using one or more types of content recognition as discussed below.

In some embodiments, the media guidance application may cross-reference the content of the media asset, or a segment of the media asset, with a database associated with overrun corrections to determine an overrun correction. For example, the content used to determine the overrun correction may relate to the entire media asset, a segment of the media asset subject to a fast-access playback operation, a segment of the media asset that relates to the progression point at which a user input ending the fast-access playback operation was received, and/or any other division of the media asset (e.g., a segment associated with a scene, chapter, etc. subject to the fast-access playback operation).

For example, the media guidance application may continually monitor each progression point's content during a fast-access playback operation and cross-reference each progression point's content with the database in real-time. For example, as the user performs the fast-access playback operation, the media guidance application may continuously determine the content of the segment of the media asset subject to the fast-access playback operation. Consequently, when the user input ending the fast-access playback operation is received, the media guidance application may immediately process the overrun correction based on the content of the portions.

In another example, the media guidance application may determine the content of the media asset before, after, or at a time irrespective of the fast-access playback operation. For example, in some embodiments, the media guidance application may only determine the content of the media asset at the progression point associated with the ending of the fast-access playback operation. In such cases, the media guidance application may determine the content of the current progression point (i.e., the progression point associated with the ending of the fast-access playback operation) after the user input ending the fast-access playback operation is received.

In another example, the media guidance application may determine the content irrespective of the fast-access playback operation. For example, upon receiving/retrieving the media asset, the media guidance application may determine the content (e.g., the genre, subject matter, etc.) of the media asset. In such cases, the predetermined content may be used for determining an overrun correction as necessary.

Based on the overrun correction, the media guidance application may automatically select a new progression point in the media asset for ending the fast-access playback operation and end the fast-access playback operation at the new progression point. For example, despite receiving a user input to end the fast-access playback operation at a first progression point, the media guidance application may select a new progression point based the overrun correction.

For example, the overrun correction may instruct the media guidance application to select a new progression point that is several frames ahead or behind the current frame of the media asset. In another example, the media guidance application may select a new progression point that is a few seconds ahead or behind the current playback position in the play length of the media asset.

In some embodiments, the media guidance application may determine overrun correction based on information other than the content of the media asset or in combination with the content of the media asset. For example, the media guidance application may determine an overrun correction based on measurements of response times of a user. In such cases, the media guidance application may enter a test/calibration mode (e.g., as discussed below in relation to FIG. 2) in which the media guidance application may test the response time of a user. For example, the media guidance application may present a media asset on a display screen that prompts the user to start and stop fast-access playback operations at certain points (e.g., as indicated by on-screen icons of varying colors). Based on the prompts, the user may enter user inputs beginning or ending the fast-access playback operations in an attempt to come as close as possible to the points. The media guidance application may repeat the prompts one or more times at various speeds. Based on the results, the media guidance application may accurately measure the response time of the user. Based on the measurements of one or more users (e.g., indicating the number of frames off of a desired point a user typically is), the media guidance application may determine an overrun correction (e.g., based on typical number of frames that the user is off).

In another example, the media guidance application may use algorithms to determine the overrun correction. For example, if a user is performing a fast-access playback operation (e.g., fast-forwarding or rewinding) at a specific speed and then instructs the media guidance application to end the fast-access playback operation, the media guidance application may select an overrun correction (e.g., a number of frames to skip forwards or backwards) based on the specific speed.

In another example, the media guidance application may base the overrun correction on a history of user behavior. For example, the media guidance application may track subsequent fast-access playback operation behavior of a user after ending a fast-access playback operation (e.g., entering a “play” command). For example, if a user ends a fast-access playback operation (e.g., a fast-forward) and then subsequently performs another fast-access playback operation (e.g., a rewind) for a particular play length (e.g., two seconds, thirty frames, etc.), the media guidance application logs this behavior (e.g., in a user profile). If media guidance application detects a pattern (e.g., the user regularly makes similar adjustments), then the media guidance application may adjust the overrun correction (e.g., an algorithm used to determine the amount of correction) to compensate for the pattern of user behavior.

In some embodiments, the media guidance application may further correlate a history of user behavior with particular content being presented during the fast-access playback operation. For example, the media guidance application may track any manual adjustments that are performed by the user subsequent to a fast-access playback operation for use in selecting an automatic overrun correction. For example, if a user typically ends a fast-access playback operation (e.g., a fast-forward) during a specific genre of programming (e.g., sports program) and then usually performs another fast-access playback operation (e.g., a rewind) for a particular play length (e.g., two seconds), the media guidance application may log this behavior (e.g., in a user profile) for use in determining overrun corrections when a user is consuming content of the same genre.

It should be noted that the embodiments described herein for detecting an overrun correction may also be applied to determining a speed associated with a fast-access playback operation. For example, the media guidance application may select a fast-access playback operation speed (e.g., the number of frames skipped during the fast-access playback operation) based on percentage of fast-access playback operation that require subsequent manual adjustments by a user or the size of the manual adjustments made by the user. For example, if a user typically overruns a particular progression point (e.g., by ten frames), the media guidance application may slow (e.g., from a rate of eight frames skipped to a rate of four frames skipped) the speed of the fast-access playback operation to reduce the chance (e.g., percentage of times) or size (e.g., number of frames) of an overrun by the user.

Furthermore, similar to other embodiments of this disclosure, the media guidance application may determine criteria (e.g., based on the current content, user, time of day, etc.) upon which to base decisions as to whether or not changes to the speed of the fast-access playback operation should be applied. For example, the media guidance application may determine whether the current content, user, etc. matches content, users, etc. that are associated with changes to the speed of the fast-access playback operation. In response to determining a match, the media guidance application may apply the changes.

In some embodiments, the media guidance application may adjust the overrun corrections associated with individual fast-access playback operations. For example, the media guidance application may log information for various factors that may affect the adjustment such as the type of fast-access playback operation, the length of the fast-access playback operation, the attentiveness of the user during the fast-access playback operation, the time of day of the fast-access playback operation, etc.

In another example, the media guidance application may determine a level of precision associated with the fast-access playback operation based on the content and select the overrun correction based on the level of user precision. For example, the media guidance application may determine whether or not the genre of the media asset is associated with a greater or lesser amount of overrun correction and select the overrun correction based on the level of user precision. For example, if the content subject to the fast-access playback operation is a sports play, the media guidance application may apply a lesser amount of overrun correction as such fast-access playback operations may be performed by a user searching for a specific frame (e.g., a frame showing whether or not a player is out of bounds), whereas if the content is a comedy program, multiple frames may be suitable (e.g., any frame after a commercials). For example, when cross-referencing the content in the database, the database may indicate a level of precision typically associated with this content or the media asset. The level of precision may be based on the behavior of a user following a fast-access playback operation (e.g., as discussed above) or other metric (e.g., an industry standard, consumer poll, or other data).

In another example, the media guidance application may determine a user associated with the fast-access playback option based on the content and select the overrun correction based on a level of skill associated with the user. For example, the media guidance application may determine based on the particular type of content being consumed (e.g., cartoons), the type of user (e.g., a young child), as that type of user is likely to consume content of that particular type. Based on the user, the media guidance application may select an overrun correction suitable for that user (e.g., featuring a greater amount of overrun correction to compensate for the limited dexterity and response time associated with a young child).

Furthermore, the media guidance application may monitor the content typically consumed by a user (e.g., as discussed below). This information may be added to a user profile along with other information (e.g., a tested response time for the user). Upon detecting that the content of the media asset is typically consumed by a particular user, the media guidance application may retrieve an overrun correction associated with the user from the user profile.

In another example, the media guidance application may determine that a progression point corresponding to the ending of a fast-access playback operation is associated with a portion of the media asset based on that portion. For example, the media guidance application may determine a portion of a media asset associated with a first progression point and select a different progression point in response to determining that the second progression point corresponds to a beginning point of the portion. For example, in response to determining that a user has ended the fast-access playback operation in the middle of an important scene, the media guidance application may automatically apply an overrun correction that returns the user to the beginning of the important scene.

Additionally or alternatively, the media guidance application may determine a portion of the media asset associated with the first progression point and select an overrun correction based on a correction associated with the portion. For example, if other users that end the fast-access playback operation typically perform subsequent fast-access playback operations (e.g., to manually correct overruns) to arrive at a particular point in the portion, the media guidance application may automatically apply an overrun correction that arrives at the point.

It should be noted that any of the above embodiments of the media guidance application determining overrun corrections based on information other than the content of the media asset or in combination with the content of the media asset may also be combined or used in series (e.g., adjusting the overrun correction in a series of iterations) with any other embodiment discussed herein. For example, each of these embodiments may be combined with embodiments determining an overrun correction of a user based on the attentiveness of the user.

In some embodiments, the media guidance application may automatically correct overruns during fast-access playback operations (e.g., fast-forward or rewind operation) based on the attentiveness of a user. For example, the media guidance application may receive a user input ending a fast-access playback operation at a first progression point in a media asset. The media guidance application may then determine an attentiveness level of a user and cross-reference the attentiveness level of the user with a database associated with overrun corrections to determine an overrun correction (e.g., a number of frames of the media asset from the first progression point to be skipped) based on the attentiveness level. The media guidance application then automatically selects a second progression point in the media asset for ending the fast-access playback operation based on the overrun correction and ends the fast-access playback operation at the second progression point.

In some embodiments, the media guidance application may cross-reference attentiveness level of the user during the entire media asset, or during a segment of the media asset, with a database associated with overrun corrections to determine an overrun correction. For example, the attentiveness level of the user used to determine the overrun correction may relate to an average of the attentiveness level of the user during an entire media asset, during a segment of the media asset subject to a fast-access playback operation, during a segment of the media asset that relates to the progression point at which a user input ending the fast-access playback operation was received, and/or any other division of the media asset (e.g., during a segment associated with a current scene, chapter, etc.).

For example, the media guidance application may continually monitor the attentiveness level of the user during a fast-access playback operation and cross-reference each progression point's content with the database in real-time. For example, as the user performs the fast-access playback operation, the media guidance application may continuously determine the attentiveness level of the user. Consequently, when the user input ending the fast-access playback operation is received, the media guidance application may immediately process the overrun correction based on the content of the portions.

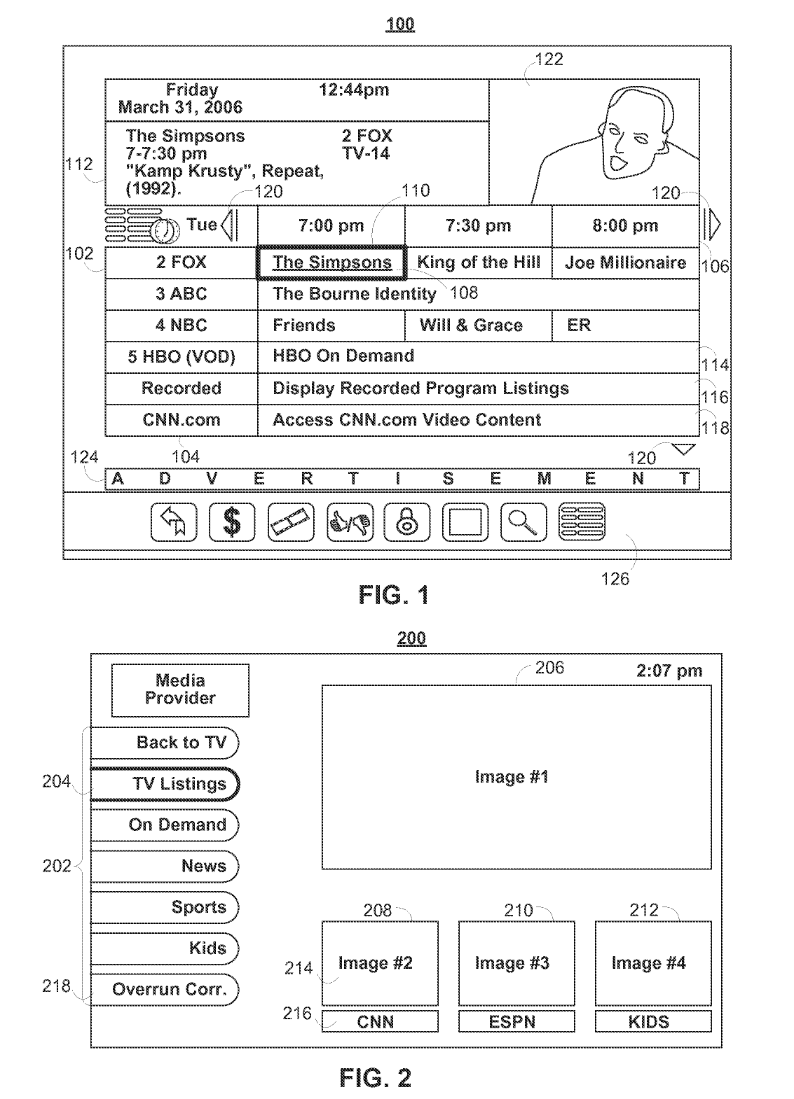

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content; provide information about a product or a service; enable purchasing of content, a product, or a service; provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.), and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Display 200 also includes selectable option 218. Selectable option 218 may be used to select options related to the automatic overrun correction. For example, the media guidance application may provide options for activating or deactivating automatic overrun corrections or setting a particular amount of automatic overrun corrections. The media guidance application may also provide options for scenarios in which particular overrun corrections and/or amounts of overrun corrections should be applied (e.g., particular fast-access playback options that have overrun corrections applied). In another example, the media guidance application may determine which technique based on one or more user inputs enter via a screen accessible from selectable option 218.

The media guidance application may also enter a test mode in response to a user input of selectable option 218. For example, during this mode, the media guidance application may present a media asset on a display screen that prompts the user to start and stop fast-access playback operations at certain points (e.g., as indicated by on-screen icons of varying colors). Based on the prompts, the user may enter user inputs beginning or ending the fast-access playback operations in an attempt to come as close as possible to the points. The media guidance application may repeat the prompts one or more times at various speeds. Based on the results, the media guidance application may accurately measure the response time of the user. Based on the measurements of one or more users (e.g., indicating the number of frames off of a desired point a user typically is), the media guidance application may determine an overrun correction (e.g., based on typical number of frames that the user is off). Additionally or alternatively, the media guidance application may allow a user to activate or deactivate a mode in which the behavior of the user (e.g., as discussed above) is monitored.

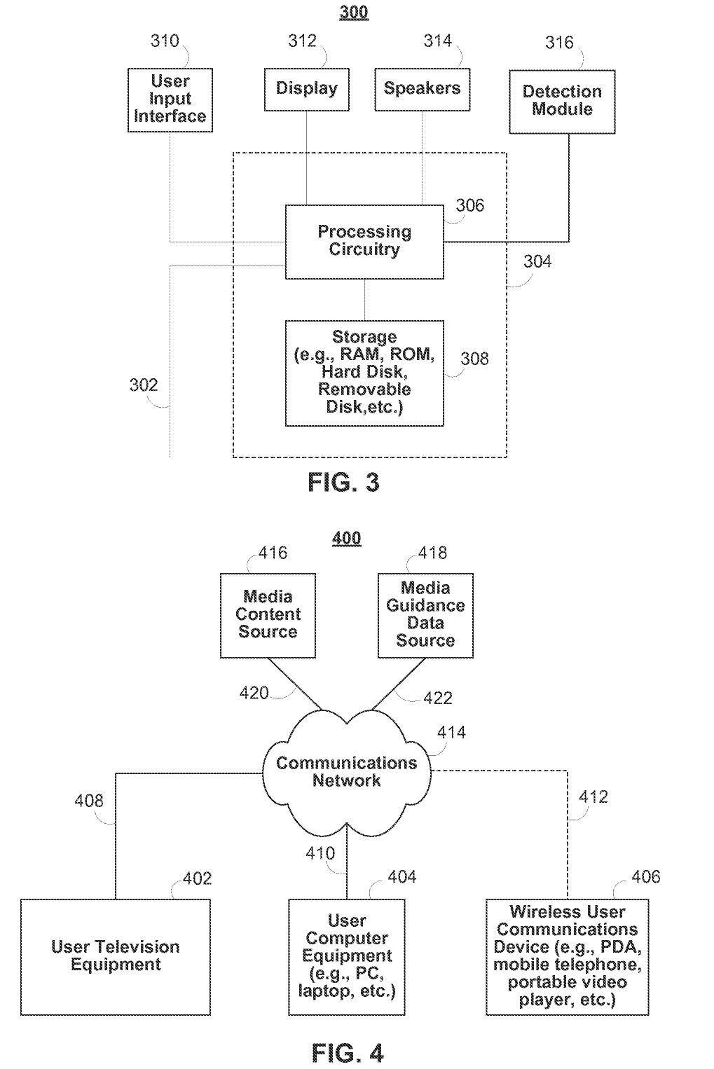

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

User equipment device 300 may also incorporate or be accessible to detection module 316. Detection module 316 may further include various components (e.g., a video detection component, an audio detection component, object recognition module, etc.). In some embodiments, detection module 316 may include components that are specialized to generate particular information (e.g., an attentiveness level of a user, the content of a media asset, etc.).

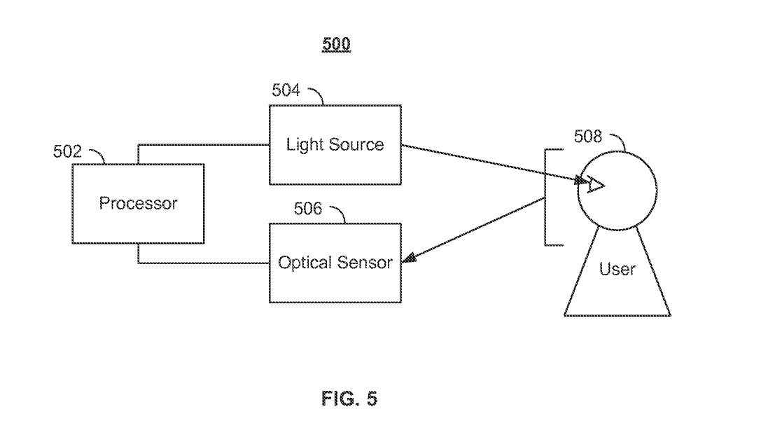

For example, as discussed below in relation to FIG. 5, detection module 316 may include an eye contact detection component, which determines or receives a location upon which one or both of a user's eyes are focused. The location upon which a user's eyes are focused is referred to herein as the user's “gaze point.” In some embodiments, the eye contact detection component may monitor one or both eyes of a user of user equipment 300 to identify a gaze point on display 312 for the user. The eye contact detection component may additionally or alternatively determine whether one or both eyes of the user are focused on display 312 (e.g., indicating that a user is viewing display 312) or focused on a location that is not on display 312 (e.g., indicating that a user is not viewing display 312). In some embodiments, the eye contact detection component includes one or more sensors that transmit data to processing circuitry 306, which determines a user's gaze point. The eye contact detection component may be integrated with other elements of user equipment device 300, or the eye contact detection component, or any other component of detection module 316, and may be a separate device or system in communication with user equipment device 300.

In some embodiments, detection module 316 may include a content recognition module. The content recognition module may use object recognition techniques such as edge detection, pattern recognition, including, but not limited to, self-learning systems (e.g., neural networks), optical character recognition, on-line character recognition (including but not limited to, dynamic character recognition, real-time character recognition, intelligent character recognition), and/or any other suitable technique or method to determine the attentiveness of a user. For example, the media application may receive data in the form of a video of the user. The video may include a series of frames. For each frame of the video, the media application may use a content recognition module or algorithm to determine the people in each of the frames or series of frames and/or the attentiveness of those people. Additionally, the content recognition module and object recognition techniques discussed above may be applied to one or more frames, playback positions, etc. of a media asset to determine the content of the media asset, or a segment of a media asset, and/or any other information for use in selecting an overrun correction.

In some embodiments, the content recognition module or algorithm may also include speech recognition techniques, including but not limited to Hidden Markov Models, dynamic time warping, and/or neural networks (as described above) to translate spoken words into text and/or processing audio data. The content recognition module may also combine multiple techniques to determine the attentiveness of a user and/or the content of a media asset.

In addition, the media application may use multiple types of optical character recognition and/or fuzzy logic, for example, when processing keyword(s) retrieved from data (e.g., textual data, translated audio data, user inputs, etc.) describing the attentiveness of a user (or when cross-referencing various types of data in databases). For example, if the particular data received is textual data, using fuzzy logic, the media application (e.g., via a content recognition module or algorithm incorporated into, or accessible by, the media application) may determine two fields and/or values to be identical even though the substance of the data or value (e.g., two different spellings) is not identical.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the media guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the media guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the media guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance application may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 with a content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIG. 5 is an illustrative example of one component of a detection module (e.g., detection module 316 (FIG. 3)), which may be accessed by a media guidance application in accordance with some embodiments of the disclosure. FIG. 5 shows eye contact detection component 500, which may be used to identify the gaze point of a user of user equipment 300, in order to determine the attentiveness level of the user. For example, the location upon which a user's eyes are focused may indicate whether or not a user is paying (or an amount a user is paying) attention to the media guidance application. For example, eye contact detection component 500 may determine whether one or both eyes of the user are focused on display (e.g., display 312 (FIG. 3)) associated with the media guidance application (e.g., indicating that a user is attentive) or focused on a location that is not on the display (e.g., indicating that a user is not attentive).

Eye contact detection component 500 includes processor 502, light source 504, and optical sensor 506. Light source 504 transmits light that reaches at least one eye of a user, and optical sensor 506 is directed at the user to sense reflected light. Optical sensor 506 transmits collected data to processor 502, and based on the data received from optical sensor 506, processor 502 determines a user's gaze point.

In some embodiments, eye contact detection component 500 is configured for determining a gaze point of a single user. In other embodiments, eye contact detection component 500 may determine gaze points for a plurality of users. Eye contact detection component 500 may identify multiple users of user devices (e.g., user equipment device 300 (FIG. 3)).

Processor 502 may be integrated with one or more light sources 504 and one or more optical sensors 506 in a single device. Additionally or alternatively, one or more light sources 504 and one or more optical sensors 506 may be housed separately from processor 502 and in wireless or wired communication with processor 502. One or more of processors 502, light sources 504, and optical sensors 506 may be integrated into a user device (e.g., user equipment device 300 (FIG. 3)).

Processor 502 may be similar to processing circuitry 306 (FIG. 3) described above. In some embodiments, processor 502 may be processing circuitry 306 (FIG. 3), with processing circuitry 306 in communication with light source 504 and optical sensor 506. In other embodiments, processor 502 may be separate from but optionally in communication with processing circuitry 306.

Light source 504 transmits light to one or both eyes of one or more users. Light source 504 may emit, for example, infrared (IR) light, near infrared light, or visible light. The light emitted by light source 504 may be collimated or non-collimated. The light is reflected in a user's eye, forming, for example, the reflection from the outer surface of the cornea (i.e. a first Purkinje image), the reflection from the inner surface of the cornea (i.e. a second Purkinje image), the reflection from the outer (anterior) surface of the lens (i.e. a third Purkinje image), and/or the reflection from the inner (posterior) surface of the lens (i.e. a fourth Purkinje image).

Optical sensor 506 collects visual information, such as an image or series of images, of one or both of one or more users' eyes. Optical sensor 506 transmits the collected image(s) to processor 502, which processes the received image(s) to identify a glint (i.e. corneal reflection) and/or other reflection in one or both eyes of one or more users. Processor 502 may also determine the location of the center of the pupil of one or both eyes of one or more users. For each eye, processor 502 may compare the location of the pupil to the location of the glint and/or other reflection to estimate the gaze point. Processor 502 may also store or obtain information describing the location of one or more light sources 504 and/or the location of one or more optical sensors 506 relative to a display (e.g., display 312 (FIG. 3)). Using this information, processor 502 may determine a user's gaze point on a display (e.g., display 312 (FIG. 3)), or processor 502 may determine whether or not a user's gaze point is the display (e.g., display 312 (FIG. 3)).

In some embodiments, eye contact detection component 500 performs best if the position of a user's head is fixed or relatively stable. In other embodiments, eye contact detection component 500 is configured to account for a user's head movement, which allows the user a more natural viewing experience than if the user's head were fixed in a particular position.

In some embodiments accounting for a user's head movement, eye contact detection component 500 includes two or more optical sensors 506. For example, two cameras may be arranged to form a stereo vision system for obtaining a 3D position of the user's eye or eyes; this allows processor 502 to compensate for head movement when determining the user's gaze point. The two or more optical sensors 506 may be part of a single unit or may be separate units. For example, a user device (e.g., user equipment device 300 (FIG. 3)) may include two cameras used as optical sensors 506, or eye contact detection component 500 in communication with the user device (e.g., user equipment device 300 (FIG. 3)) may include two optical sensors 506. In other embodiments, each of the user device (e.g., user equipment device 300 (FIG. 3)) and eye contact detection component 500 may include an optical sensor, and processor 502 receives image data from the optical sensor of the user device and the optical sensor of eye contact detection component 500. Processor 502 may receive data identifying the location of optical sensor 506 relative to a display (e.g., display 312 (FIG. 3)) and/or relative to each other and use this information when determining the gaze point.

In other embodiments accounting for a user's head movement, eye contact detection component 500 includes two or more light sources for generating multiple glints. For example, two light sources 504 may create glints at different locations of an eye; having information on the two glints allows the processor to determine a 3D position of the user's eye or eyes, allowing processor 502 to compensate for head movement. Processor 502 may also receive data identifying the location of light sources 504 relative to a display (e.g., display 312 (FIG. 3)) and/or relative to each other and use this information when determining the gaze point.

In some embodiments, other types of eye contact detection components that do not utilize a light source may be used. For example, optical sensor 506 and processor 502 may track other features of a user's eye, such as the retinal blood vessels or other features inside or on the surface of the user's eye, and follow these features as the eye rotates. Any other equipment or method for determining one or more users' gaze point(s) not discussed above may be used in addition to or instead of the above-described embodiments of eye contact detection component 500.

It should be noted that eye contact detection component 500 is but one type of component that may be incorporated into or accessible by detection module 316 (FIG. 3) or the media application. Other types of components, which may generate other types of data (e.g., video, audio, textual, etc.) are fully within the bounds of this disclosure.

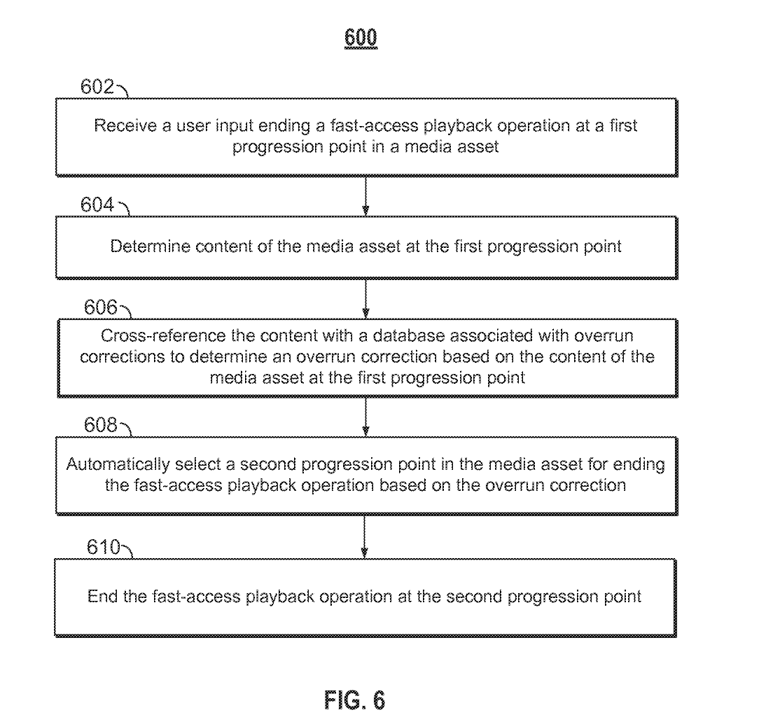

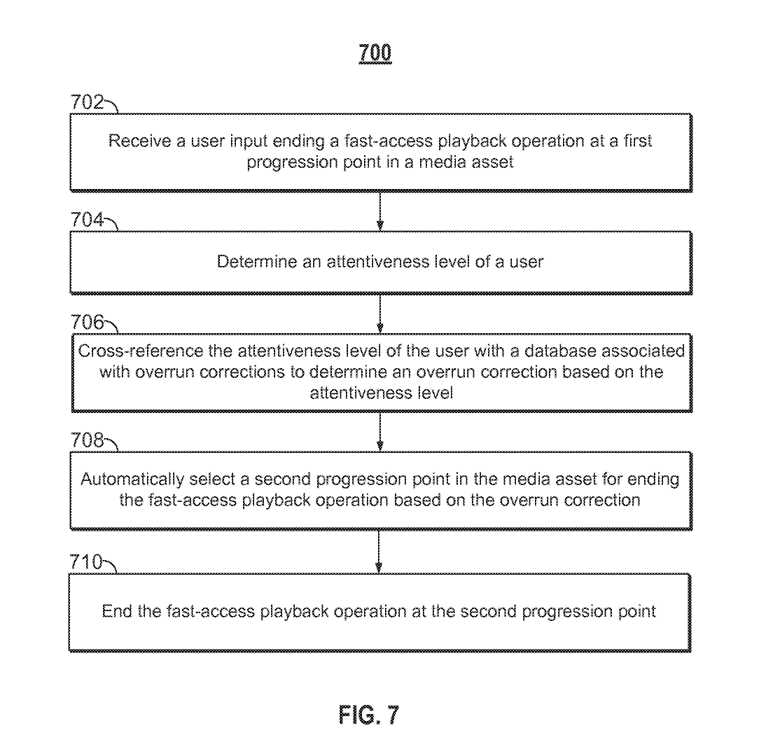

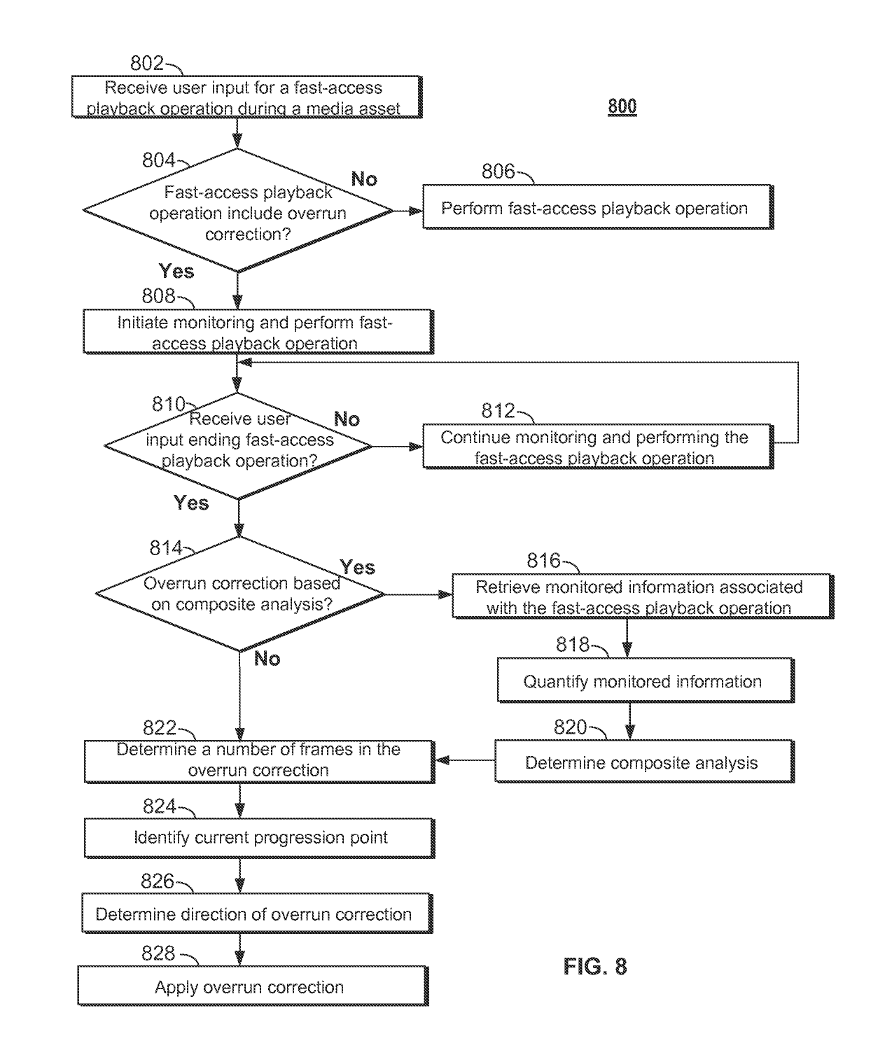

FIG. 6 is a flowchart of illustrative steps for automatically correcting overruns during fast-access playback operations based on the content of a media asset. It should be noted that process 600 or any step thereof could be performed on, or provided by, any of the devices shown in FIGS. 3-4. For example, process 600 may be executed by control circuitry 304 (FIG. 3) as instructed by a media guidance application implemented on user equipment 402, 404, and/or 406 (FIG. 4) in order to provide automatic overrun corrections. In addition, one or more steps of process 600 may be incorporated into or combined with one or more steps of any other process or embodiment (e.g., process 700 (FIG. 7) or process 800 (FIG. 8)).

At step 602, the media guidance application receives a user input ending a fast-access playback operation at a first progression point in a media asset. For example, while a user is viewing a media asset on a display device (e.g., display 312 (FIG. 3)) associated with a user device (e.g., user equipment device 402, 404, and/or 406 (FIG. 4)), the media guidance application may receive a first user input (e.g., via user input interface 310 (FIG. 3)) requesting a fast-access playback operation (e.g., a rewind operation) followed by a second user input (e.g., via user input interface 310 (FIG. 3)) ending the fast-access playback operation (e.g., the rewind operation).

At step 604, the media guidance application determines the content of the media asset at the first progression point. For example, the media guidance application may determine (e.g., via control circuitry 304 (FIG. 3)) the content of the media asset based on data included with the media asset (e.g., metadata). Additionally or alternatively, the media guidance application may determine (e.g., via control circuitry 304 (FIG. 3)) the content of the media asset based on information related to the content of a media asset received from a remote source (e.g., media guidance data source 418 (FIG. 4) and/or any location accessible via communications network 414 (FIG. 4)) or local storage (e.g., storage 308 (FIG. 3)). For example, in response to a user request (e.g., entered via user input interface 310 (FIG. 3)) to access a media asset, the media guidance application may query a database (e.g., storage 308 (FIG. 3) and/or any database accessible via communications network 414 (FIG. 4)) for data related to the content of the media asset.

In some embodiments, the media guidance application may determine (e.g., via control circuitry 304 (FIG. 3)) the content of a media asset (or information related to the content of the media asset) based on information provided from detection module 316 (FIG. 3)). For example, if the media asset is a video, the media application (e.g., via detection module 316 (FIG. 3)) may analyze each frame of the video or a particular segment of the video (e.g., the frame associated with the first progression point) to determine the content of each frame. For each frame of the video, the media application may use a content recognition module or algorithm to identify objects in the frame and/or other data associated with the frame (e.g., subtitle data and/or media guidance data) to determine the content.

At step 606, the media guidance application cross-references the content with a database associated with overrun corrections to determine an overrun correction based on the content of the media asset at the first progression point. For example, in response to determining the content, the media guidance application may query a database (e.g., storage 308 (FIG. 3) and/or any database accessible via communications network 414 (FIG. 4)) in order to determine an overrun correction.

For example, the media guidance application may (e.g., via control circuitry 304 (FIG. 3)) input the determined content into a lookup table database (e.g. located locally at storage 308 (FIG. 3) or remotely at media content source 416 (FIG. 4), media guidance data source 418 (FIG. 4), and/or any device accessible via communications network 414 (FIG. 4)). The lookup table database may determine a particular record associated with the inputted content and retrieve a field associated with the overrun correction (e.g., indicating a specific value, number of frames, length of time, direction of correction, etc.) associated with that record. The database may then output the value associated with the field for receipt (e.g., via I/O path 302 (FIG. 3)) by the media guidance application.

At step 608, the media guidance application automatically selects a second progression point in the media asset for ending the fast-access playback operation based on the overrun correction. For example, in response to receiving/retrieving an overrun correction from the database, the media guidance application applies the correction (e.g., via control circuitry 304 (FIG. 3)) to the first progression point. For example, if the value of the overrun correction was negative five frames, the media guidance application selects (e.g., via control circuitry 304 (FIG. 3)) a second progression point that is five frames before the first progression point.

At step 610, the media guidance application ends the fast-access playback operation at the second progression point. For example, upon selecting the second progression point, the media guidance application causes (e.g., via control circuitry 304 (FIG. 3)) the media asset to begin playing from the second progression point.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 6.

FIG. 7 is a flowchart of illustrative steps for automatically correcting overruns during fast-access playback operations based on the attentiveness of a user. It should be noted that process 700 or any step thereof could be performed on, or provided by, any of the devices shown in FIGS. 3-4. For example, process 700 may be executed by control circuitry 304 (FIG. 3) as instructed by a media guidance application implemented on user equipment 402, 404, and/or 406 (FIG. 4) in order to provide automatic overrun corrections. In addition, one or more steps of process 700 may be incorporated into or combined with one or more steps of any other process or embodiment (e.g., process 600 (FIG. 6) or process 800 (FIG. 8)).

At step 702, the media guidance application receives a user input ending a fast-access playback operation at a first progression point in a media asset. For example, while a user is viewing a media asset on a display device (e.g., display 312 (FIG. 3)) associated with a user device (e.g., user equipment device 402, 404, and/or 406 (FIG. 4)), the media guidance application may receive a first user input (e.g., via user input interface 310 (FIG. 3)) requesting a fast-access playback operation (e.g., a rewind operation) followed by a second user input (e.g., via user input interface 310 (FIG. 3)) ending the fast-access playback operation (e.g., the rewind operation).

At step 704, the media guidance application determines an attentiveness level of the user. For example, the media guidance application may determine (e.g., via control circuitry 304 (FIG. 3)) the attentiveness level of the user based on data received from one or more components of detection module 316 (FIG. 3)). For example, eye contact detection component 500 (FIG. 5)) may determine whether one or both eyes of the user are focused on display (e.g., display 312 (FIG. 3)) associated with the media guidance application (e.g., indicating that a user is attentive) or focused on a location that is not on the display (e.g., indicating that a user is not attentive).

Eye contact detection component 500 (FIG. 5)) may also include information related to how often a user looked away, which may be used by the media guidance application to determine the attentiveness level of the user. For example, if a user looked away from the display associated with the media guidance application more than three times during a particular period of time (e.g., during the fast-access playback operation), the media guidance application may determine that the user has a low level of attentiveness. In contrast, if a user did not looked away from the display associated with the media guidance application during a particular period of time (e.g., during the fast-access playback operation), the media guidance application may determine that the user has a high level of attentiveness.

At step 706, the media guidance application cross-references the attentiveness level of the user with a database associated with overrun corrections to determine an overrun correction based on the attentiveness level of the user. For example, in response to determining the attentiveness level of the user, the media guidance application may query a database (e.g., storage 308 (FIG. 3) and/or any database accessible via communications network 414 (FIG. 4)) in order to determine an overrun correction.

For example, the media guidance application may (e.g., via control circuitry 304 (FIG. 3)) input the determined attentiveness level of the user into a lookup table database (e.g. located locally at storage 308 (FIG. 3) or remotely at media content source 416 (FIG. 4), media guidance data source 418 (FIG. 4), and/or any device accessible via communications network 414 (FIG. 4)). The lookup table database may determine a particular record associated with the inputted attentiveness level of the user and retrieve a field associated with the overrun correction (e.g., indicating a specific value, number of frames, length of time, direction of correction, etc.) associated with that record. The database may then output the value associated with the field for receipt (e.g., via I/O path 302 (FIG. 3)) by the media guidance application.

At step 708, the media guidance application automatically selects a second progression point in the media asset for ending the fast-access playback operation based on the overrun correction. For example, in response to receiving/retrieving an overrun correction from the database, the media guidance application applies the correction (e.g., via control circuitry 304 (FIG. 3)) to the first progression point. For example, if the value of the overrun correction was positive three seconds, the media guidance application selects (e.g., via control circuitry 304 (FIG. 3)) a second progression point that is three seconds after the first progression point.

At step 710, the media guidance application ends the fast-access playback operation at the second progression point. For example, upon selecting the second progression point, the media guidance application causes (e.g., via control circuitry 304 (FIG. 3)) the media asset to begin playing from the second progression point.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 7.

FIG. 8 is a flowchart of illustrative steps for applying an overrun correction. It should be noted that process 800 or any step thereof could be performed on, or provided by, any of the devices shown in FIGS. 3-4. For example, process 800 may be executed by control circuitry 304 (FIG. 3) as instructed by a media guidance application implemented on user equipment 402, 404, and/or 406 (FIG. 4) in order to provide automatic overrun corrections. In addition, one or more steps of process 800 may be incorporated into or combined with one or more steps of any other process or embodiment (e.g., process 600 (FIG. 6) or process 700 (FIG. 7)).

At step 802, the media guidance application receives a user input for a fast-access playback operation. For example, while a user is viewing a media asset on a display device (e.g., display 312 (FIG. 3)) associated with a user device (e.g., user equipment device 402, 404, and/or 406 (FIG. 4)), the media guidance application may receive a user input (e.g., via user input interface 310 (FIG. 3)) requesting the media guidance application performs a fast-access playback operation (e.g., a rewind operation).

At step 804, the media guidance application determines whether or not the fast-access playback operation includes frame skipping. For example, the media guidance application may determine (e.g., via control circuitry 304 (FIG. 3)) whether or not a fast-access playback operation is associated with automatic overrun correction. For example, in some embodiments, certain fast-access playback operation (e.g., skip to the next chapter, start over, etc.) may not be subject to automatic overrun correction.

Furthermore, in some embodiments, the media guidance application may have particular settings associated with fast-access playback operations. For example, the media guidance application may retrieve a user profile (e.g., from storage 308 (FIG. 3) or any location accessible via communications network 414 (FIG. 4)) that indicate special settings to apply to one or more fast-access playback operations. For example, as explained above in FIG. 2, the media guidance application may retrieve settings for activating or deactivating automatic overrun corrections or selecting particular amounts of automatic overrun corrections based on the user (or prior user selections). The media guidance application may also retrieve settings for scenarios in which particular overrun corrections and/or amounts of overrun corrections should be applied (e.g., particular fast-access playback options that have overrun corrections applied).

If the media guidance application determines at step 804 that the fast-access playback operation does not include an overrun correction, the media guidance application proceeds to step 806 and performs the fast-access playback operation. If the media guidance application determines that that the fast-access playback operation does include an overrun correction, the media guidance application proceeds to step 808.

At step 808, the media guidance application initiates monitoring and performs the fast-access playback operation. For example, the media guidance application may base overrun corrections on the determined (e.g., via detection module 316 (FIG. 3)) content of the media asset subject to the fast-access playback operation and/or the attentiveness level of the user.

In some embodiments, the media guidance application continually monitors (e.g., via detection module 316 (FIG. 3)) the content associated with each progression point of the media asset subject to the fast-access playback operation and store the monitored information (e.g., in storage 308 (FIG. 3)) for cross-referencing each progression point's content with a database in real-time. In some embodiments, the media guidance application continually monitors (e.g., via detection module 316 (FIG. 3)) attentiveness levels of the user during the fast-access playback operation and store the monitored information (e.g., in storage 308 (FIG. 3)) for cross-referencing attentiveness levels of the user with the database in real-time.

At step 810, the media guidance application determines whether or not a user input ending the fast-access playback operation is received. For example, while a user is viewing a media asset on a display device (e.g., display 312 (FIG. 3)) associated with a user device (e.g., user equipment device 402, 404, and/or 406 (FIG. 4)), the media guidance application may receive a first user input (e.g., via user input interface 310 (FIG. 3)) requesting the media guidance application performs a fast-access playback operation (e.g., a rewind operation) followed by a second user input (e.g., via user input interface 310 (FIG. 3)) ending the fast-access playback operation.

If the media guidance application determines that a user input ending the fast-access playback operation is not received (e.g., via user input interface 310 (FIG. 3)), the media guidance application proceeds to step 812 and continues monitoring (e.g., via detection module 316 (FIG. 3)) and performing the fast-access playback operation before returning to step 810. If the media guidance application determines that a user input ending the fast-access playback operation is received, the media guidance application proceeds to step 814.

At step 814, the media guidance application determines whether or not the overrun correction is based on a composite analysis. For example, in some embodiments, the media guidance application may determine (e.g., via control circuitry 304 (FIG. 3)) the overrun correction based on the content of the media asset at the progression point associated with the ending of the fast-access playback operation. In some embodiments, the media guidance application may determine (e.g., via control circuitry 304 (FIG. 3)) the overrun correction based on the attentiveness level of the user when the user input ending the fast-access playback operation is received. In such cases, a composite analysis is not necessary, and the media guidance application proceeds to step 822.

In some embodiments, the media guidance application may determine (e.g., via control circuitry 304 (FIG. 3)) the overrun correction based on the content of the media asset the during the entire fast-access playback operation. Likewise, in some embodiments, the media guidance application may determine (e.g., via control circuitry 304 (FIG. 3)) the overrun correction based on the attentiveness level of the user during the entire fast-access playback operation. In such cases, a composite analysis is necessary, and the media guidance application proceeds to step 816.

At step 816, the media guidance application retrieves the monitoring associated with the fast-access playback operation. For example, while monitoring (e.g., via detection module 316 (FIG. 3)) content of the media asset subject to the fast-access playback operation and/or the attentiveness level of the user during the fast-access playback operation the media guidance application may store the monitored information in memory (e.g., storage 308 (FIG. 3)). In response to determine that the overrun correction is based on a composite analysis, the media guidance application may retrieve (e.g., via control circuitry 304 (FIG. 3)) the monitored information.

At step 618, the media guidance application quantifies the monitored information according to respective metrics. For example, the metric used by the media guidance application to quantify an attentiveness level of a user (e.g., the frequency/amount of eye contact of the user) may include measuring a length of time that the user is making eye contact with the display (e.g., display 312 (FIG. 3)) associated with the media guidance application during the fast-access playback operation, whereas the metric used by the media guidance application to quantify the content of the media asset may include determining a number of times, if any, an object or a type of object (e.g., an appearance by a particular character in a movie, the presence of a scoring play in a sports game, etc.) appears during the fast-access playback operation.

At step 820, the media guidance application determines a composite analysis for the monitored information. For example, the media guidance application may determine (e.g., via control circuitry 304 (FIG. 3) an average attentiveness level of the user or a single representation of the content of the media asset during the fast-access playback operation.

For example, if the fast-access playback operation includes three progression points and the monitored information indicates that the user attentiveness level for each progression point corresponded to twenty percent attentive, ten percent attentive, and sixty percent attentive, respectively, the media guidance application may determine that the composite analysis of the attentiveness level of the user corresponds to thirty percent. It should be noted that the arithmetic mean or average referred to herein, is but one way to determine a composite analysis. Mathematical modes, medians, or other types of central or typical values may also be used.

In another example, if the fast-access playback operation includes three progression points and the monitored information indicates that the content of the media asset included one scoring play (e.g., in a televised football game) between the three progression points, the media guidance application may determine that the composite analysis of all the three progression points is associated with a scoring play.

At step 822, the media guidance application determines a number of frames in the overrun correction. For example, as discussed in relation to step 606 (FIG. 6) and 706 (FIG. 7), the media guidance application may cross-reference the results of the composite analysis with a database associated with overrun corrections to determine a particular number of frames (or length of time) associated with the overrun correction. For example, in response to determining the attentiveness level of the user corresponds to thirty percent, the media guidance application may query a database (e.g., storage 308 (FIG. 3) and/or any database accessible via communications network 414 (FIG. 4)) and receive an output that indicates a thirty percent attentiveness level corresponds to a seven frames in an overrun correction. Likewise, in response to determining the content of the fast-access playback operation includes a scoring play, the media guidance application may query a database (e.g., storage 308 (FIG. 3) and/or any database accessible via communications network 414 (FIG. 4)) and receive an output that indicates a scoring play corresponds to no overrun correction.

At step 824, the media guidance application identifies a current progression point. For example, as discussed above in relation to step 604 (FIG. 6) and step 704 (FIG. 7), the media guidance application may identify a progression point that corresponds to the actual progression point at which the fast-access playback operation ending. At step 826, the media guidance application determines which direction to apply the overrun correction to. In some embodiments, the direction of the overrun correction will correspond to the opposite direction of the fast-access playback operation. For example, if the fast-access playback operation was a rewind operation, the media guidance application may determine the overrun is applied in the positive direction (respective to the linear progression of the media asset). If the fast-access playback operation was a fast-forward operation, the media guidance application may determine the overrun is applied in the negative direction (respective to the linear progression of the media asset).

It should be noted that in some embodiments, the direction of the overrun correction may not be associated with the type of fast-access playback operation. For example, if the overrun correction corresponds to the beginning of a scene (e.g., as discussed above), the direction of the overrun correction may correspond to the location of the beginning of the scene.

At step 826, the media guidance application applies the overrun correction. For example, upon selecting a direction and amount of overrun correction, the media guidance application (e.g., via control circuitry 304 (FIG. 3)) applies the direction and amount of overrun correction to the current progression point to identify a new progression point. The media guidance application then begins playing (e.g., via control circuitry 304 (FIG. 3)) the media asset from the new progression point.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 8.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for automatically correcting overruns during fast-access playback operations, the method comprising:
receiving a user input ending a fast-access playback operation at a first progression point in a media asset;
determining an attentiveness level of a user;
cross-referencing the attentiveness level of the user with a database associated with overrun corrections to determine an overrun correction based on the attentiveness level;
automatically selecting a second progression point in the media asset for ending the fast-access playback operation based on the overrun correction; and
ending the fast-access playback operation at the second progression point.

2. The method of claim 1, wherein the overrun correction indicates a number of frames of the media asset from the first progression point to be skipped.

3. The method of claim 1, wherein the fast-access playback operation includes a fast-forward or rewind operation.

4. The method of claim 1, further comprising:
continually monitoring attentiveness levels of the user during the fast-access playback operation; and
cross-referencing attentiveness levels of the user with the database in real-time.

5. The method of claim 1, wherein the attentiveness level is based on the average attentiveness of the user during the fast-access playback operation.

6. The method of claim 1, further comprising determining the attentiveness level of the user prior to receiving the user input.

7. The method of claim 1 further comprising:
determining a user associated with the fast-access playback option based on content of a media asset subject to the fast-access playback operation; and
selecting the overrun correction based on a level of skill associated with the user.

8. The method of claim 1 further comprising:
determining content of the media asset; and
cross-referencing the content with the database associated with overrun corrections to determine the overrun correction based on the content.

9. The method of claim 1 further comprising:
determining a portion of the media asset associated with the first progression point; and
selecting the overrun correction based on a correction associated with the portion.

10. The method of claim 1, further comprising:
determining a portion of the media asset associated with the first progression point; and
selecting the second progression point in response to determining that the second progression point corresponds to a beginning point of the portion.

11. A system for automatically correcting overruns during fast-access playback operations, the system comprising control circuitry that:
receives a user input ending a fast-access playback operation at a first progression point in a media asset;
determines an attentiveness level of a user;
cross-references the attentiveness level of the user with a database associated with overrun corrections to determine an overrun correction based on the attentiveness level;
automatically selects a second progression point in the media asset for ending the fast-access playback operation based on the overrun correction; and
ends the fast-access playback operation at the second progression point.

12. The system of claim 11, wherein the overrun correction indicates a number of frames of the media asset from the first progression point to be skipped.

13. The system of claim 11, wherein the fast-access playback operation includes a fast-forward or rewind operation.

14. The system of claim 11, wherein the control circuitry:
continually monitors attentiveness levels of the user during the fast-access playback operation; and
cross-references attentiveness levels of the user with the database in real-time.

15. The system of claim 11, wherein the attentiveness level is based on the average attentiveness of the user during the fast-access playback operation.

16. The system of claim 11, wherein the control circuitry determines the attentiveness level of the user prior to receiving the user input.

17. The system of claim 11, wherein the control circuitry:
determines a user associated with the fast-access playback option based on content of a media asset subject to the fast-access playback operation; and
selects the overrun correction based on a level of skill associated with the user.

18. The system of claim 11, wherein the control circuitry:
determines content of the media asset; and
cross-references the content with the database associated with overrun corrections to determine the overrun correction based on the content.

19. The system of claim 11, wherein the control circuitry:
determines a portion of the media asset associated with the first progression point; and
selects the overrun correction based on a correction associated with the portion.

20. The system of claim 11, wherein the control circuitry:
determines a portion of the media asset associated with the first progression point; and
selects the second progression point in response to determining that the second progression point corresponds to a beginning point of the portion.

21-50. (canceled)
